(19) United States
(12) Patent Application Publication
(10) Pub. No.: US 2010/0015582 A1
(43) Pub. Date: Jan. 21, 2010

(54) 421 Tunsi-nippon cognations

(76) Inventor: Noureddin Zahmoul, Houston, TX (US)

Correspondence Address: Noureddin Zahmoul, 189 Litchfield Lane, Houston, TX, 77024, US

(21) Appl. No.: 12/218,965

(22) Filed: Jul. 21, 2008

(51) Int. Cl. G09B 19/06

(52) U.S. Cl. 434/157

(57) ABSTRACT

Four hundred twenty one NIPPON TUNSI Cognates (NTC), are delineated in this auspicious sui generis discovery. One hundred seven root verbs, one hundred seven different root adjectives, as well as two hundred seven separate root nouns, conjunctions, particles etc, are presented in Tunsi and Japanese (Hiragana and Katagana) including an English translation and a Romanized transcription for each Japanese word. The Sumerian alternation, and the Cassidy Code with its trilogy (apocope, alternations, and reverse) will suffice to bridge and reconcile the Regular Differences (RD) between the Tunsi and the Japanese vocabularies. Another brought forward proof that MT is adumbrated in all languages of our planet. This LRC divulges a simple average of one twenty four (1.24) RD, or Degree Of Separation (DOS) in four hundred twenty one NTC. This research reveals that there is one and only language family. Mother tongue is the proto language, and all others are its various languages

### CROSS-REFERENCE TO RELATED APPLICATION

“NOT APPLICABLE”

### STATEMENT REGARDING FEDERALLY SPONSORED RESEARCH OR DEVELOPMENT

“NOT APPLICABLE”

### REFERENCE TO SEQUENCE LISTING, A TABLE, OR A COMPUTER PROGRAM LISTING COMPACT DISC APPENDIX

“NOT APPLICABLE”

### BACKGROUND OF THE INVENTION

Language Origins Research, LOR, and Long Range Comparison, LRC, of languages, are the invention fields. I speak fluently one of the Hamitic Languages, (Tunsi), as well as, at least one Semitic (Arabic) language. I have mastered, since my childhood in Tunis, the two of them. My college studies were about international business. I graduated at the Business School of Lausanne, Switzerland. During thirty some years I practiced diverse kinds of businesses (banking, bartering, industrial, and manufacturing). However, since the age of four, while speaking, exclusively, Tunsi at home, learning Arabic writing in Coranic school, French language in elementary school, and English in high school, I have been amazed by the differences between the alphabets, the missing twelve Basic Guttural Consonants, BGC, in the French, and the ten lacking BGC in English. Long time after, during a business trip to Finland I was fascinated by the twelve consonant Suomi (Finnish) language, and its peculiar modus of plural (Sami, pl. Suomi). It is also an agglutinative language with the same plural process, as in Tunsi. The missing BGC, and the peculiar plural became an issue of acute importance to me.

At the age of fifty eight, I deliberately retired to spend seventy eight months at Indiana University (Bloomington) where I passed a Philosophical Doctorate in The Uralic Studies, with two minors in Suomi (Finnish) studies, and in “Paganism and Islam in Central Asia”. My Master dissertation was about: “An Etymological Grouping of the Finnish Words Participating in the Quantitative Gradation: PP>P”. And My Ph.D. dissertation treated The “Historical Layers of The Selkup Vocabulary”. The Selkup/Shelghum language is part of the Uralic languages, and still spoken by the Selkup people along the Taz river and the Arctic Circle, in Siberia, where a year is a day, half of it light, and the other half night. During my stay in Indiana, I mastered the common connections between eleven Uralic languages, and the methodology of their cognations researches.

During the Paris workshop (1997), (see Annex II), Dr G. Décsy underpinned the following:
“a) Humans lived less than 1% (one percent) of their phylogenetic history with languages (i.e. 35,000 years out 5 millions years). b) Monogenesis is correct with regard to the sound production. All languages of the world produce vowels/consonants in the same way. c) Polygenesis is correct with regard to the sound sequence (word) production. d) Words in large were set up late (post 10,000). e) Grammar is a late variation of vocabulary based on frequency relationships. f) Lexicon precedes grammar. g) The natural form of plural is reduplication”.
   At the same workshop Dr B. H. Bichackjian, pinpointed the real problem of LOR, and “Paris Prohibition”:
“We could make a meaningful contribution by tracing the development of linguistic features and by inferring the principles that have guided the evolution of languages. But that would require the abandoning of a cherished myth, and mainstream linguists are not ready for it”.
   The cherished myth started with Sir Rawlington (1860) when he discovered the Behustan rocks, and deciphered their three languages. In his LRC of the 98 Indo European languages he initiated the rationale of straight cognation. Since then, all LRC of the world languages, have focused on separate wide swaths of obvious cognations, and LOR's goal has been since tracing back MT with the traditional rationale. The BGC have been totally absent during the two Paris workshops of LOR (1985, and 1997).

On the planet Earth where we live together, the limits of the possible are the following five altarpiece factoids which are uncontrolled, incontrollable and incontrovertible:
In every second, the living forest (north of the Saharan areas) is moving by six microns. Its motion of 23° latitude during the last 130 centuries will reverse itself during the next same span of time. This is the Precession effect discovered by Milutin Malenkovitch (1930s). Precession ramifications created a seven degree north latitude (36th to 43rd) Mediterra Evergreen Zone, MEZ, a buffer zone, land of perpetual plenty, where several languages thrived with different consonantal gamut during the last 15,000 years (see Annex I) from Spain to Japan.
In every second, the world population increases by four more human beings. Two will be Buddhist: Chinese, Hindu, or South Asiatic. The other two will be Monotheist (Judeo, Christian, and Muslim believers). All Earth population communicates by means of faith, beliefs, and discourses. There are seven hundred remnant languages (98 of them are Indo European) according to Dr. Guyla Decsy (Global Linguistic Connections, GLC, 1983, 8), but only 300 according to Dr Johanna Nickols from the American Association for Advancement of Science, Berkeley, Calif. The association of LOR is actively trying to trace back the original Mother Tongue, Mont. Hence adequate research is critically needed to show its existence and unifying effect.
The Human body possesses twenty eight phalanges, and twenty eight teeth, (let alone the four wisdom teeth). The Human adult skull encompasses twenty two (22) bones and six (6) ear ossicles encased within the temporal bones. The Sun year counts thirteen folds four weeks. Twenty eight thumbs (the nose's hypotenuse size) is the horizontal span from the left major's tip to the right one. The arm measures seven thumbs (from the major's tip to the elbow). It is the peculiarity of every human being. The foot has four, and the cubit only six, (thumb's tip to the elbow). A divine design indeed.
The twenty eight consonant Mother tongue, is adumbrated in all languages. Being the main one, all others are its dialects. Pending the deciphering of the Etruscan, this study will demonstrate that we have only one family of different languages with one Mother Tongue.
The Cassidy Code is sui generic. Its three pillars (apocopy, alternations, reverse made it unprecedented, unheard of before February the ninth of 2005, unfussy, unflappable, unique, universal, unequivocal enforcer, and not likely to be surpassed. Take it out of the picture, and there is no telling what might have happened to the cognations. (Annex Ell).

My research aims to add a parallel path to the traditional way with my LRC of the two following Linguae Purae: Japanese language (with sixteen consonants), and Hamitic Tunsi (with twenty eight consonants), (see Annex IV). My approach differs from traditional rationale by including BGC with their alternates, and reversal in order to transcend all boundaries between the, alleged, different phyla of languages. Here again one might sense, the adumbrated MT basic tenets and their remnant hidden paths, traces, patterns from the remnant languages, and particularly through the two Linguae Purae of this LRC corpus, each of them belonging to an “alleged” separate phylum of languages. Three questions initiated my quest:

A) Is there a problem inside the problem?;
B) What is the problem outside the problem?
C) What are the barriers, the missing components, the pattern of Regular Differences (RD) and the breakthrough(s)?.

### BRIEF SUMMARY OF THE INVENTION

Four hundreds twenty one Tunsi-Nippon cognations are discovered. It is a Sui Generis in the L.R.C. field, and also an immense leap of faith in the L.O.R., due Mother Tongue. These two vocabularies belong to two separate phyla of languages on the one hand. Their respective geographical far away locations make them very difficult to assume or imply any borrowing, or crossed influence, on the other hand. The Cassidy Code knack will suffice to bridge the Five hundreds twenty four Regular Differences (RD). This discovery demonstrates the average of RD is one twenty four (1.24) for the four hundreds twenty one NTC.

### BRIEF DESCRIPTION OF THE SEVERAL VIEWS OF THE DRAWING

NOT APPLICABLE”.

### DETAILED DESCRIPTION OF THE INVENTION

The Hamito-Semitic languages kept all the following BGC, and the (h)

| | | | | | | | | | | |
|---|---|---|---|---|---|---|---|---|---|---|
| gh | dh | [symbol] | kh | [symbol] | h | [symbol] | th | th | ss | tt |

Suomi, Hamitic phyla and Latin kept also the front vowels: (ä), (ö). The Hamito-Semitic writing eradicated the vowels, and kept the above mentioned BGC. Among the mentioned BGC, [symbol] will be in Arabic letters.

Problem inside the problem?: A schism emerged between the primordial languages, their perdurable BGC, and the Classical Articulatory Organs Languages, CAOL. By ignoring BGC, the CAOL evolved separately from the Hamito Semitic and Dravidian phyla towards a gradual simplification. It clearly appears that LOR cannot trace MT without including the BGC.

Problem outside the problem: A trend of gradual and irresistible simplification is omnipresent among the Indo-European, and the Uralic languages and the Japanese. This question is more complex and needs a compleat and thorough knowledge of the Regular Differences (RD), between our two languages LRC. We need to look at them from every angle, to hover over words of interest, to reach critical insights as well as leads, to delve deeply and thoroughly in order to detect recurrent analogies, RD, and reversals (double metathesis one for the extreme, and the other for the median consonants).

A complete reckoning of RD hidden patterns ought to be accomplished in order to reach a thorough understanding of the paradigms that guided their respective evolution. The thin way pronunciation superseded the BGC articulation, among the Indo-European, the Uralic, and the Japanese alphabets. Seven thousand years before Grimm and Verner laws, the Sumerian started the finer articulation, Eme Sal, and the trend is still streamlining the language of the world.
We have a clear-cut distinction between Eme Gur and Eme Sal (see Mr M. L. Thomsen, Sumerian Language, 1981, 87):

| Eme-gur | Eme-sal | |
|---|---|---|
| d > z | dug = ze.eb | ‘good, sweet’ dugud = ze.bi-da ‘heavy’ |
| g > b | igi = i. bi | ‘eye’ sha-g = sha-b ‘heart’ |
| g > m | digir = dim.me.er | ‘god, gish’ = mu ‘tree’ |
| g > n | sag = she.en | ‘head’ |
| h > g | ha.lam = ge.le.eg | ‘to destroy’ |
| m > n | munus = nunus | ‘woman’ |
| m > g | sum = ze.eg | ‘to give’ |
| n > l | nigir = li.bi.ir | ‘herald’ |
| n > m | nu.gig = mu.gi.ib | ‘hierodule’ |
| n > sh | nin = shen | ‘lady’ |
| s > z | sum = ze.eg | ‘to give’ |
| s > sh | sig = she.en | ‘brick’ |
| k > s | | |

| | | | |
|---|---|---|---|
| And vowel changes are: | a > e | alim = e.lum | ‘deer’ |
| | i > e | inim = e.ne.eg | ‘word’ |
| | i > u | I = u | ‘fat’ |
| | u > e | udu = e.ze | ‘sheep’ |

Eme sal preempted the Grim law by avoiding the hard g>m, and b, and Verner law, by stating the g>d alternation.

What are the missing components?: During my twenty year quest I have effectuated a deep cryptanalysis of the missing BGC. They seem to have been transient in the Indo-European, the Uralic languages, and the Japanese. Their transience means that MT might have had the laryngeal h, as well as the other ten BGC. During their transience, they gradually faded out. Apocope or several unvoiced consonants might have superseded them. My cryptanalysis allowed me to detect a gamut of mostly unvoiced consonants, as viable alternates to each missing voiced BGC in Indo European, Uralic, and Japanese languages. Ultimately, the fundamental aim has always been, about reaching a smoother and thinner articulation called in Finnish “viene ããnne” or finer pronunciation. Hopefully, Simo Parpola in his publication, (Transliteration of Sumerian Problems and Prospects, 1975, 254) underlined the common denominator as follows:
“Most of the phonetic differences between Main dialect and Eme Sal can be explained as autonomous sound changes occasioned by a forward shift of the basis of articulation (U>I=high back>high front); (K>P>T=velar>labial/dental stop); (Ng>M, >N=velar>labial/dental nasal); (Sh>S=post-alveolar>alveolar fricative); (S>Sh)=alveolar>dental fricative), which seems to indicate that backward-flanged phonemes (i.e. narrow vowels, and labial or dental, including alveolar consonants) were considered ‘finer’ than their forward-flanged counterparts.”
   This spontaneous, automatic, and autonomous sound mutation by an instinctive and pliable apocope, is part of a harmony instinct embedded in human neuro system. Simplification, or intricacy and redundancy eradication is an integral part of human mindset. Nowadays, conventional initial mnemonics or acronyms like MRI, IRS, CNN, FDA, LRC, LOR, EU, AARP, USA, URSS, NAFTA, UN, and ASAP, sound simpler, familiar, and EZ to process. The vowel free writing started with the Hamito-Semitic languages. Getting rid of the vowels while keeping alive all the BGC, has been the panacea of Hamito-Semitic languages.

After a thorough research of all hidden mutations, and reversals, one can trace, discern, unveil, and infer through their developmental system, the RD through apocope, alternations, and reversal. Hereafter a corpus of 421 Nippon-Tunsi root words, submitted to a Long Range Comparision (LRC). Not to forget that seven time zones separate Tunis from Tokyo:

CORPUS of 421 NIPPON-TUNSI COGNATIONS:

| | | | | | |
|---|---|---|---|---|---|
| HIRAGANA | ROMANIZED | TUNSI | ENGLISH | HATAKANA | RD |

107 Verbs

| | | | | | |
|---|---|---|---|---|---|
| [symbol] | Agamemasu | A( [symbol] )meru | Worship, adore | [symbol] | One |
| [symbol] | Aisimasu | ( [symbol] )aishu | Love | [symbol] | One |
| [symbol] | Ajiwamasu | ( [symbol] )ajiba (na) | Taste; Savor; | [symbol] | Two |
| [symbol] | Akasimasu | ( [symbol] )akasu | Disclose | [symbol] | One |
| [symbol] | Arukimasu | ( [symbol] )aruku | Walk | [symbol] | One |
| [symbol] | Aserimasu | ( [symbol] )assara | Fade; Discolor | [symbol] | One |
| [symbol] | Assimasu | ( [symbol] )assuru | Press | [symbol] | One |
| [symbol] | Ataemasu | ( [symbol] )atau | Give | [symbol] | One |
| [symbol] | Chijimasu | (Q)i(z)imi | Shrink | [symbol] | Two |
| [symbol] | Damasimasu | (Tt)ama( [symbol] )u | Swindle | [symbol] | Two |
| [symbol] | Dasimasu | Da(zz)u | Put forth, issue | [symbol] | One |
| [symbol] | Dekimasu | De(qq)u | Be able, Finish | [symbol] | One |
| [symbol] | Demasu | Demmasu | Leave, Appear | [symbol] | Zero |
| [symbol] | Erabimasu | Errab(ii) | Choose; Elect | [symbol] | Zero |
| [symbol] | Fukuremasu | Fu(kh)ur | Swell, Brag | [symbol] | One |
| [symbol] | Fukimasu | (N)'fu(kh)u | Blow | [symbol] | One |
| [symbol] | Furumamasu | Furuma | Behave | [symbol] | Zero |
| [symbol] | Hajikimasu | ( [symbol] )a(z)a(q) | Snap | [symbol] | Three |
| [symbol] | Hajimemasu | ( [symbol] )aza(q)o | Make an effort | [symbol] | Two |
| [symbol] | Hakarimasu | ( [symbol] )akker | Measure, Weigh | [symbol] | One |
| [symbol] | Hanasimasu | Hennas | Chat | [symbol] | Zero |
| [symbol] | Hashirimasu | Hisheri | Run; Rush | [symbol] | Zero |
| [symbol] | Hatakimasu | Ha(tt)ak | Spend all one's money | [symbol] | One |
| [symbol] | Hayabikimasu | Haya bik(r)i | Leave early | [symbol] | One |
| [symbol] | Haya(ri)masu | ( [symbol] )ayyar | Come into Fashion | [symbol] | One |
| [symbol] | Hazuremasu | (Kh)a(s)ar | Fail; Lose | [symbol] | Two |
| [symbol] | Hazusimasu | ( [symbol] )azzuzu | Remove, Take off | [symbol] | One |
| [symbol] | Herasimasu | He(rr)assu | Lessen, decrease | [symbol] | One |
| [symbol] | Hikimasu | ( [symbol] )(u)ku | Run over; Grind | [symbol] | Two |
| [symbol] | Homemasu | A( [symbol] )me(rr) | Admire | [symbol] | One |
| [symbol] | Iimasu | Ii | Say | [symbol] | Zero |
| [symbol] | Ikimasu | A(y)a | Go | [symbol] | One |
| [symbol] | Imasu | A(y)a | Go | [symbol] | One |
| [symbol] | Isogimasu | I(z)o(r)o(b)u | Hurry | [symbol] | Three |
| [symbol] | Iyashimasu | Iya(z)y(ni) | Humble | [symbol] | Two |
| [symbol] | Kabamasu | (Kh)abba | Support; protect | [symbol] | One |
| [symbol] | Kaeremasu | Ka( [symbol] )ereru | Return, Repeat | [symbol] | One |
| [symbol] | Kagimasu | (Sh)e(m)u | Smell | [symbol] | Two |
| [symbol] | Kaimasu | (Q)a(dh)a | Buy | [symbol] | Two |
| [symbol] | Kakimasu | (Q)ai(d)u | Write | [symbol] | Two |
| [symbol] | Koimasu | (Q)o(ll)i | Ask | [symbol] | Two |
| [symbol] | Kiremasu | (B)a(l)aa( [symbol] ) | Expire, be disconnected | [symbol] | Three |
| [symbol] | Koemasu | (Q)o(w)e | Exceed; Surpass | [symbol] | Two |
| [symbol] | Kojiremasu | (Q)ojjiru | Become complicated | [symbol] | One |
| [symbol] | Komarimasu | At (Kh)ammar | Be upset; be a hassle | [symbol] | One |
| [symbol] | Kowasumasu | ( [symbol] )awa(j)u | Break smtg, | [symbol] | Two |
| [symbol] | Kuremasu | (Q)iir | Give | [symbol] | One |
| [symbol] | Ku'u(masu) | Ku(l)u | eat, bite | [symbol] | One |
| [symbol] | Messimasu | Me(tt) | Die | [symbol] | One |
| [symbol] | Moraimasu | Moro(w)a | Receive | [symbol] | One |
| [symbol] | Motsumasu | At Ma(tt)a( [symbol] ) | Have | [symbol] | Two |
| [symbol] | Nagemasu | Na(gh)e(r) | Throw; Give up | [symbol] | Two |
| [symbol] | Najimumasu | Najim/(L)ajim | Become accustomed to | [symbol] | One |
| [symbol] | Naremasu | (K)arreru\ | Become accustomed to | [symbol] | One |
| [symbol] | Nikumimasu | Ni(q)uma | Hate | [symbol] | One |
| [symbol] | Nozomimasu | (L)ozemu | Hope | [symbol] | One |
| [symbol] | Nugimasu | Na( [symbol] )i | Take off (shoes) | [symbol] | One |
| [symbol] | Nukemasu | Na(qq)i | Remove | [symbol] | One |
| [symbol] | Nukasimasu | Na(q)as | Omit, Skip | [symbol] | One |
| [symbol] | Odorokimasu | Odoruku | Wonder | [symbol] | Zero |
| [symbol] | Ochimasu | O( [symbol] )siru | Drop | [symbol] | One |
| [symbol] | Okasumasu | ( [symbol] )okasu | Infringe; Violate | [symbol] | One |
| [symbol] | Okurimasu | (W)o(kh)oru | Be late; Be behind | [symbol] | Two |
| [symbol] | Omoimasu | (Kh)a(mm)am | Think | [symbol] | Two |
| [symbol] | Osimasu | ® (L)u(zz)u | Push | [symbol] | Three |
| [symbol] | Osheimasu | Oshe(n)iya | Tell | [symbol] | One |
| [symbol] | Oyagumasu | ( [symbol] )o(w)a(m)u | Swim | [symbol] | Three |
| [symbol] | Owarimasu | ( [symbol] )owaru | End; Terminate | [symbol] | One |
| [symbol] | Saberimasu | (Sh)abre(sh) | Talk | [symbol] | Two |
| [symbol] | Sakumasu | ® (Q)atta( [symbol] ) | Tear | [symbol] | Three |
| [symbol] | Sawarumasu | (Ss)awaru | Touch | [symbol] | One |
| [symbol] | Sosugimasu | So(bb)u | Pour | [symbol] | One |
| [symbol] | Suimasu | Si(ff)u | Sip | [symbol] | One |
| [symbol] | Sukumasu | ( [symbol] )u(bb)o | Like | [symbol] | Two |
| [symbol] | Sumimasu | ( [symbol] )y(sh)u | Live | [symbol] | Two |
| [symbol] | Shi'iremasu | Shi'ire | Purchase; Stock | [symbol] | Zero |
| [symbol] | Shimasu | Shi(d)u | Do | [symbol] | One |
| [symbol] | Shimemasu | Shime(te) | Turn off; Close | [symbol] | Zero |
| [symbol] | Shinumasu | ® (M)a(t)a | Die | [symbol] | Three |
| [symbol] | Shippaisuru | ® (F)a(sh)i(l) | Fail | [symbol] | Three |
| [symbol] | Shirimasu | ® (L)a(q)a | Find out, Know | [symbol] | Three |
| [symbol] | Tamamasu | (illi) (Th)ama | Tolerate | [symbol] | One |
| [symbol] | Tataemasu | (Sidi) Tata | Bless | [symbol] | Zero |
| [symbol] | Todokimasu | Todo(qq)u | Deliver, Notify | [symbol] | One |
| [symbol] | Todomarimasu | At doome | Stay | [symbol] | Zero |
| [symbol] | Tokimasu | ® (Q)e(dd)o | Solve, Undo | [symbol] | Three |
| [symbol] | Tomemasu | Tomete | Stop, Park | [symbol] | Zero |
| [symbol] | Torimasu | Toor | Take | [symbol] | Zero |
| [symbol] | Toosimasu | Too(z)u | Pass (object) through | [symbol] | One |
| [symbol] | Toimasu | To(ll)a( [symbol] )u | Inquire, Ask | [symbol] | Two |
| [symbol] | Tsukaimasu | At (z)u(g)ate | Use | [symbol] | Two |
| [symbol] | Tsukamimasu | At (z)ukame | Catch | [symbol] | One |
| [symbol] | Tsukemasu | At sukkar | Attach; Mend | [symbol] | One |
| [symbol] | Tsukuremasu | At su(g)aru | Make | [symbol] | One |
| [symbol] | Tsumemasu | At ( [symbol] )ameru | Charge | [symbol] | One |
| [symbol] | Tsumimasu | At ( [symbol] )a(bb)i | Load | [symbol] | One |
| [symbol] | Umaremasu | ( [symbol] )umore | Be born | [symbol] | One |
| [symbol] | Uzukimasu | ( [symbol] )u(z)u(q)u | Ache; Throb | [symbol] | Three |
| [symbol] | Yasumimasu | Yasumo | Rest, Fast | [symbol] | Zero |
| [symbol] | Yomimasu | (W)omia (signs | Read | [symbol] | One |
| [symbol] | Yorokubimasu | Yorokibu | Be happy | [symbol] | Zero |
| [symbol] | Wakarimasu | Wa(qq)aru | Consider | [symbol] | One |
| [symbol] | Watarimasu | (K)a(th)ar/Wa(ff)ar | Extend; stretch | [symbol] | Two |
| [symbol] | Watasimasu | (Q)ata( [symbol] )u | Pass; Carry across | [symbol] | Two |
| [symbol] | Zuremasu | Zure(ru) | Shift out of place, | [symbol] | Zero |

B) 107 Adjectives

| | | | | | |
|---|---|---|---|---|---|
| [symbol] | Appare | A(ff)aare | Splendid | [symbol] | One |
| [symbol] | Atsui | A( [symbol] )sui | Thick | [symbol] | One |
| [symbol] | Atarashii | ( [symbol] )atar(y)a | Fresh, New | [symbol] | One |
| [symbol] | Ayashii | ( [symbol] )ayasha | Dubious | [symbol] | One |
| [symbol] | Boodai na | Boudaina | Huge; enormous | [symbol] | Zero |
| [symbol] | Burai (na) | Barrani | Rude; Impolite | [symbol] | Zero |
| [symbol] | Bushoo (na) | Bu(kh)y(l) | Lazy; Inactive | [symbol] | Two |
| [symbol] | Chisai | ® (S)ia-(gh)a | Small | [symbol] | Three |
| [symbol] | Chuukan (no) | (Sh)uukka(l) | Intermediate | [symbol] | Two |
| [symbol] | Ekitai | E(q)ita(y)i( [symbol] ) | Liquid | [symbol] | Two |
| [symbol] | Erai | Erray | Distinguished | [symbol] | Zero |
| [symbol] | Fukoo (na) | ( [symbol] )u(q)oona | unfortunate | [symbol] | Two |
| [symbol] | Fukusuu | Fu(qq)usa | Plural | [symbol] | One |
| [symbol] | Fushigi (na) | Fushi(k)u | Magical, Mysterious | [symbol] | One |
| [symbol] | Fusoo (na) | Fu(ss)oo( [symbol] )a | Over one's ability | [symbol] | Two |
| [symbol] | Futari | Fituri | Double | [symbol] | Zero |
| [symbol] | Futoo (na) | F(i)tna | Unjust; unfair | [symbol] | One |
| [symbol] | Ganjoo | (Gh)anjoo | Strong; Sturdy | [symbol] | One |
| [symbol] | Genki (na) | (J)ensh | Healthy; Energetic | [symbol] | One |
| [symbol] | Gesu(na) | Gue( [symbol] )o(r) | Base; Mean spirited | [symbol] | Two |
| [symbol] | Geisha | (Q)ei( [symbol] )sha | Gueisha | [symbol] | Two |
| [symbol] | Hageshii | ( [symbol] )a(k)eshaa | Fierce; tempestuous | [symbol] | Two |
| [symbol] | Hajime | ( [symbol] )ajime | First | [symbol] | One |
| [symbol] | Hakanai | Ha(sh)a naa | Ephemeral; empty | [symbol] | One |
| [symbol] | Hansa (na) | ( [symbol] )a(m)(ss)a | Troublesome | [symbol] | Three |
| [symbol] | Haradatashii | Harada(ha) | Upseting | [symbol] | One |
| [symbol] | Hare | Ha(n)e | Fine | [symbol] | One |
| [symbol] | Hatashinai | ( [symbol] )atashi(r)a | Endless | [symbol] | Two |
| [symbol] | Heion (na) | ( [symbol] )eion | Peaceful, calm | [symbol] | One |
| [symbol] | Hen (na) | Hennani | Funny | [symbol] | Zero |
| [symbol] | Heta (na) | henta(la) | Poor at smtng | [symbol] | One |
| [symbol] | Hidari | ® Rade(s)/( [symbol] )idara | West; Left | [symbol] | Two |
| [symbol] | Hikui | ( [symbol] )i(shsh)i | Low | [symbol] | Two |
| [symbol] | Hima | Himma | Dignified | [symbol] | Zero |
| [symbol] | Hoofu (na) | ( [symbol] )oof'na | full of | [symbol] | One |
| [symbol] | Hoka no | ( [symbol] )o(q)ana | Another; some | [symbol] | Two |
| [symbol] | Honto (no) | ® ( [symbol] )o(qq)o | Real; True | [symbol] | Three |
| [symbol] | Hoogai (na) | ( [symbol] )ooga | Exorbitant | [symbol] | One |
| [symbol] | Houwa | Houwa | oxyded, Sturated | [symbol] | Zero |
| [symbol] | Idai (na) | ( [symbol] )adaa (na) | Great; Grand | [symbol] | One |
| [symbol] | Ido | ( [symbol] )iddo | Latitude | [symbol] | One |
| [symbol] | Ii | Ii | Good | [symbol] | Zero |
| [symbol] | Joobu-na | (Z)ebuna | Healthy, Strong | [symbol] | One |
| [symbol] | Joohin | (W)ooh(r)a | Elegant, Refined | [symbol] | Two |
| [symbol] | Judai(na) | Jeddi | Serious | [symbol] | Zero |
| [symbol] | Kabin(na) | Kabina | Oversensitive | [symbol] | Zero |
| [symbol] | Kanoo(na) | Ka(y)no (ii) | Possible | [symbol] | One |
| [symbol] | Kara | (Q)ara( [symbol] )a | Empty | [symbol] | Two |
| [symbol] | Karai | (M)oorra; ( [symbol] )aarra | Bitter, Hot | [symbol] | One |
| [symbol] | Kashikoi | (Q)ash(q)a(l)a | Wise | [symbol] | Three |
| [symbol] | Keiyoushi | Kei(f)oushi | Adjective | [symbol] | One |
| [symbol] | Kirai | (Kh)ira | Pretty | [symbol] | One |
| [symbol] | Kitanazi | I(Kh)it na( [symbol] )i | Dirty | [symbol] | Two |
| [symbol] | Kiza-na | (Gh)iza(w)i | Snobbish, conceited | [symbol] | Two |
| [symbol] | Kodai-na | (Q)odai-(m)a | Ancient | [symbol] | Two |
| [symbol] | Koeta | (G)oetta | Overweigh; fertile | [symbol] | One |
| [symbol] | Kohei (na) | Koh(ei)na | Fair; unbiaised | [symbol] | Zero |
| [symbol] | Koi | (Q)oi | Thick; Strong | [symbol] | One |
| [symbol] | Kokei | (Q)o(w)ei | Solid | [symbol] | Two |
| [symbol] | Koko-no | (W)o( [symbol] )o(d)o | Individual | [symbol] | Three |
| [symbol] | Konomashi | Ko(l)omashi | Pleasant, desirable | [symbol] | One |
| [symbol] | Koorai-(no) | (Q)oorai(no) | Elderly, Old Patient | [symbol] | One |
| [symbol] | Kowai | (Kh)owa(f) | Scared | [symbol] | Two |
| [symbol] | Koun(na | ( [symbol] )ooun | Lucky, Fortunate | [symbol] | One |
| [symbol] | Kudoi | (Q)addo | Repetitous, Persistent | [symbol] | One |
| [symbol] | Ma'atarashii | Ma'atarashii | Brand new | [symbol] | Zero |
| [symbol] | Mazurashii | Mazu(w)ar | Unusual | [symbol] | One |
| [symbol] | Meihaku(na) | Me(h)i( [symbol] )a(q)u | Obvious | [symbol] | One |
| [symbol] | Meimon(na) | Meimoun | Renowned, Prestigious | [symbol] | Zero |
| [symbol] | Meishi | ® Sheima | Name | [symbol] | One |
| [symbol] | Mijikai | (N)i(z)i(q)u | Brief, Short | [symbol] | Two |
| [symbol] | Mottomo (na( | Mo(dh)omona | Logical Rational | [symbol] | One |
| [symbol] | Mukanjoo (na, ni) | Mo(q)aj(w)al | Apathetic | [symbol] | Two |
| [symbol] | Museigen | Mu(z)e(y)en | Variegated | [symbol] | Two |
| [symbol] | Mushinkei (na, ni) | Mushen(gu)e(l)u | Insensitive, | [symbol] | Two |
| [symbol] | Mushoku (na) | Musheku(l)a | Unemployed | [symbol] | One |
| [symbol] | Nai | (L)a; Nai | No, Not | [symbol] | Zero |
| [symbol] | Najimi (no) | Najimu/Lajimu | Familiar, Regular | [symbol] | Zero |
| [symbol] | Nami (no) | Nami | Mediocre | [symbol] | Zero |
| [symbol] | Nemai | Ne(y)em | Sleepy | [symbol] | One |
| [symbol] | Ooboo | ( [symbol] )oboo | Tyrannic | [symbol] | One |
| [symbol] | Okurita | O(kh)urtu | Belated | [symbol] | One |
| [symbol] | Ookii | (W)osa( [symbol] )a | Large | [symbol] | Two |
| [symbol] | Onaji | Onaji | Equal, Same | [symbol] | Zero |
| [symbol] | Ooppira | ( [symbol] )o(ff)ora | Open | [symbol] | Two |
| [symbol] | Oraka | (W)ora(q) | Easygoing | [symbol] | Two |
| [symbol] | Sabishi | (Z)abbish | Lonely, Desolate | [symbol] | One |
| [symbol] | Saigo (na) | Sai(b)ou | Final, End | [symbol] | One |
| [symbol] | Sanzana | (Z)anzana | Devastating | [symbol] | One |
| [symbol] | Shiboo | Shi( [symbol] )a(m)a | Fat | [symbol] | Two |
| [symbol] | Shigau | Shi(k)aw | Different | [symbol] | One |
| [symbol] | Shin (no) | Shinno(wa) | Fair, Genuine, True | [symbol] | Zero |
| [symbol] | Shinsei (na) | Shin(sh)eina | Sacred, Holy | [symbol] | One |
| [symbol] | Shooryoo (no) | Shoo(w)aya | little bit | [symbol] | One |
| [symbol] | Shuuaku (na) | (At) Shuakna | Extremely Ugly | [symbol] | One |
| [symbol] | Takai | (Tt)aa(q) | Expensive | [symbol] | Two |
| [symbol] | Tappuri (no) | Ta( [symbol] )(b)uri | Abundant | [symbol] | Two |
| [symbol] | Tekido na | Te(q)iddo | Appropriate; Moderate | [symbol] | One |
| [symbol] | Urayameshii | Urayamashi | Envious | [symbol] | Zero |
| [symbol] | Ureshii | U(n)eshii | Joyful | [symbol] | One |
| [symbol] | Wabashii | Wabashu | Lonely, Dreary | [symbol] | Zero |
| [symbol] | Wakate (no) | Wa(q)atii | Young, | [symbol] | One |
| [symbol] | Waku Waku | Wa(kh)a Wa(kh)a | Exciting | [symbol] | One |
| [symbol] | Yabani | (J)aba(l)t | Uncivilized | [symbol] | Two |
| [symbol] | Yasashii | ( [symbol] )a(t)ashii | Easy | [symbol] | Two |
| [symbol] | Zenra (no) | Zon(t)a | Stark naked, Bare | [symbol] | One |
| [symbol] | Zokei | (Dh)okei | Knowledgeable | [symbol] | One |
| [symbol] | Zonzai(na) | Zanzana | Impolite, Coarse | [symbol] | Zero |

C) 207 Nouns, Conjunctions, Particules, Interjections, etc . . .

| | | | | | |
|---|---|---|---|---|---|
| [symbol] | Aijoo | ( [symbol] )aizzo | Love, Affection | [symbol] | One |
| [symbol] | Aisatu | ( [symbol] )aishu | Greetings | [symbol] | One |
| [symbol] | Aka | ( [symbol] )akari | Red | [symbol] | One |
| [symbol] | Akushu | Aka(h)u | Shake hands | [symbol] | One |
| [symbol] | An | ( [symbol] )al | Idea, Solution | [symbol] | One |
| [symbol] | Anago | ( [symbol] )ana(sh)a | Sea eel | [symbol] | Two |
| [symbol] | Anata | Anti | You | [symbol] | Zero |
| [symbol] | Ao | (Dh)ao | Blue | [symbol] | One |
| [symbol] | Ashita | ( [symbol] )ashiya | Tomorrow | [symbol] | One |
| [symbol] | Assaku | ( [symbol] )a(zz)a(q)u | Pression | [symbol] | Three |
| [symbol] | Atama | A(d)ama(gh) | Head | [symbol] | Two |
| [symbol] | Ayamachi | Ayama(sh)i | Fault, error; Blunder | [symbol] | One |
| [symbol] | Banwa | Ba(l) wa | Evening | [symbol] | One |
| [symbol] | Bara-de | Bara de | Separately | [symbol] | Zero |
| [symbol] | Bishoo | Bish-bisho | Smile | [symbol] | Zero |
| [symbol] | Boori | Boori (shiira) | Excessive profit | [symbol] | Zero |
| [symbol] | Boucyou | (W)oucy( [symbol] )ou | Expansion | [symbol] | Two |
| [symbol] | Bun | Bo(l) tta | Half | [symbol] | One |
| [symbol] | Buai | Ba(y)i | Rate, Percentage | [symbol] | One |
| [symbol] | Butsu | Buussu | Hit | [symbol] | One |
| [symbol] | Chanto | (Q)a(dd)o | Exactly | [symbol] | Two |
| [symbol] | Chira | Chira | Direction | [symbol] | Zero |
| [symbol] | Chome | ( [symbol] )oma | Quarter | [symbol] | One |
| [symbol] | Chotto | Cho(dd)o | A little moment | [symbol] | One |
| [symbol] | Dakeru | (Dh)akeru | Able | [symbol] | One |
| [symbol] | Dandan | Danden | Gradually | [symbol] | Zero |
| [symbol] | Deashi | Da( [symbol] )(s)a | Start | [symbol] | Two |
| [symbol] | Dema | (Th)ama | Unsupported rumor | [symbol] | One |
| [symbol] | Dewa | (T)ewa ((N)ow) | Now; Well; Then | [symbol] | One |
| [symbol] | Doozo | Doozoo | Please Do | [symbol] | Zero |
| [symbol] | Dore dake | ® Kadaa(sh) | How much, How many | [symbol] | Two |
| [symbol] | Dou | Da(r)/Duar | House | [symbol] | One |
| [symbol] | Ee | Ee | Yes | [symbol] | Zero |
| [symbol] | Fuukaku | Fuu(Q)a(l)Ku(l) | Style; Character | [symbol] | Two |
| [symbol] | Fukuru | Fi(t)uri | Double | [symbol] | One |
| [symbol] | Fura fura to | Fura | Precipitously | [symbol] | Zero |
| [symbol] | Furukae | Furuka( [symbol] )e | Alternative, Substitute | [symbol] | One |
| [symbol] | Futa | Futa | Cover | [symbol] | Zero |
| [symbol] | Gachoo | (W)oo(zz)a | Goose | [symbol] | Two |
| [symbol] | Gai | (Q)a( [symbol] )a | Ground | [symbol] | Two |
| [symbol] | Gai | (Q)ay | Harm, Damage | [symbol] | One |
| [symbol] | Gakkou | (Sh)ookel | School | [symbol] | One |
| [symbol] | Geisha | (Q)ei( [symbol] )sha | Gueisha | [symbol] | Two |
| [symbol] | Gendoo | (J)endoo | Behavior, Discipline | [symbol] | One |
| [symbol] | Genshoo | (J)eneshoo | Phenomenon | [symbol] | One |
| [symbol] | Haaku | Ha(kk)aKa | Grasp | [symbol] | One |
| [symbol] | Hachi | ( [symbol] )ash'ya | Edge, End | [symbol] | One |
| [symbol] | Hachi | ( [symbol] )a(shsh)i | Bee (Not Honeybee) | [symbol] | Two |
| [symbol] | Hakari | ( [symbol] )akkara | Scale (weight) | [symbol] | One |
| [symbol] | Hakken | Ha(qq)a(q)/ | Discovery | [symbol] | Two |
| [symbol] | Hako | ( [symbol] )okka | Box | [symbol] | One |
| [symbol] | Han | (Sh)a(t)a(r) | Half | [symbol] | Three |
| [symbol] | Hara | ( [symbol] )ara (center) | Stomach | [symbol] | One |
| [symbol] | Harawata | (Gh)arawata | Intestines; bowels; | [symbol] | One |
| [symbol] | Hasami | ® Ma(q)a(ss) | Scissors | [symbol] | Three |
| [symbol] | Hassoo | ( [symbol] )ass | Idea, Inspiration, Notion | [symbol] | One |
| [symbol] | Hata | ( [symbol] )a(tt)a (style) | Banner; Flag | [symbol] | Two |
| [symbol] | Hate | (Gh)a(d)i | Most remote point | [symbol] | One |
| [symbol] | Hatoba | ( [symbol] )atoba (Wood) | Pier; Warf; quay | [symbol] | One |
| [symbol] | Haya | Haya | Speedy | [symbol] | Zero |
| [symbol] | Hayakumo | Haya(q)umo | Already | [symbol] | One |
| [symbol] | Hayasa | ( [symbol] )ayassa | Speed (regulator) | [symbol] | One |
| [symbol] | Henka | ( [symbol] )anka | Change; Variety | [symbol] | One |
| [symbol] | Hensoo | ( [symbol] )en(sh)oo | Disguise | [symbol] | Two |
| [symbol] | Hi | ( [symbol] )ay | Day | [symbol] | One |
| [symbol] | Hijoo | Hijaa | Emergency | [symbol] | Zero |
| [symbol] | Hikairu | ( [symbol] )a(q)eru | Refrain from | [symbol] | Two |
| [symbol] | Hikaku | ( [symbol] )ikakuhom | Comparison | [symbol] | One |
| [symbol] | Hito Bito | ( [symbol] )ito(t) wi Bito(t0 | People | [symbol] | Two |
| [symbol] | Hiyouka | (A)haouka | Appreciation | [symbol] | One |
| [symbol] | Hogo | ( [symbol] )o(qq)o | Protection, care | [symbol] | Two |
| [symbol] | Hon'ne | ( [symbol] )on'ne(n) | True feeling | [symbol] | One |
| [symbol] | Hookoku | ( [symbol] )oo(qq)i(q)u | Report | [symbol] | Three |
| [symbol] | Hooroo | ( [symbol] )orroo | Wanderer | [symbol] | One |
| [symbol] | Hossa | (Gh)ossa | Attack; a Fit | [symbol] | One |
| [symbol] | Ichi | (Y)i(qq)ish | One | [symbol] | Two |
| [symbol] | Iffuku | Illifu(q)u | Clothing | [symbol] | One |
| [symbol] | Ii | Ii | Sure | [symbol] | Zero |
| [symbol] | Iie | Iie | No | [symbol] | Zero |
| [symbol] | Ikura | ( [symbol] )ikkaro | How much | [symbol] | One |
| [symbol] | Ima | Imma | moment; Now | [symbol] | Zero |
| [symbol] | Iro | i(l)oo(n) | Color | [symbol] | One |
| [symbol] | Iroho | Ro( [symbol] )o | The Basics | [symbol] | One |
| [symbol] | Iroke | Iroo(q)a | Sexiness | [symbol] | One |
| [symbol] | Jikan | ® No(w)o(d) | A lot, Time | [symbol] | Three |
| [symbol] | Jobun | Job(y)n | Preface, Foreword | [symbol] | One |
| [symbol] | Jochoo | Jaach | courage | [symbol] | Zero |
| [symbol] | Jooge | ® (Q)a(dd) | Measure | [symbol] | Three |
| [symbol] | Jooren | J(ii)ren (neighbors) | Regular Customer | [symbol] | One |
| [symbol] | Juusho | ( [symbol] )uusho | Address | [symbol] | One |
| [symbol] | Juwaki | Juwa(q)a | Telephone | [symbol] | One |
| [symbol] | Kaiho | (Q)ai( [symbol] )o | Smtg to take care of | [symbol] | Two |
| [symbol] | Kaiwa | Ka(l)aa(m) | Conversation | [symbol] | Two |
| [symbol] | Kame | Ka(gh)e(dh) | Paper | [symbol] | Two |
| [symbol] | Kane/Okane | (M)a(l)e | Money | [symbol] | Two |
| [symbol] | Kankaku | (M)an(h)a(j)u | Sense (of) | [symbol] | Three |
| [symbol] | Karada | (B)ada(n)u | Body | [symbol] | Two |
| [symbol] | Kare | (H)a(n)i | Fine | [symbol] | Two |
| [symbol] | Kate | (Gh)adi | Far | [symbol] | One |
| [symbol] | Kaya | Kaya (Illness) | Mosquito net | [symbol] | Zero |
| [symbol] | Keisan | (Q)eissan | Calculus | [symbol] | One |
| [symbol] | Kenka | ( [symbol] )aa(r)ka | Argument | [symbol] | Two |
| [symbol] | Kishoo | Kishoo(sh) | Temperament, Nature | [symbol] | Two |
| [symbol] | Kobu | ( [symbol] )o(d)ba | Bump, Hump | [symbol] | Two |
| [symbol] | Kochoo | ® (Sh)o(m)oo | Exageration | [symbol] | Three |
| [symbol] | Komogi | ® Gomo( [symbol] ) | Wheat | [symbol] | Two |
| [symbol] | Koodai | (Q)oodaima | Ancient times | [symbol] | One |
| [symbol] | Koodoo | (Q)ooddoo | Behavior | [symbol] | One |
| [symbol] | Koe | ® ( [symbol] )o(ss) | Voice | [symbol] | Three |
| [symbol] | Kompai | Kom(b)ai | Together | [symbol] | One |
| [symbol] | Koto | (Q)ato( [symbol] )a | Thing, affair, matter | [symbol] | Two |
| [symbol] | Kotoba | Kotiba | Language, Word | [symbol] | Zero |
| [symbol] | Kuchi | (Sh)a(h)a(r) | Month | [symbol] | Three |
| [symbol] | Kudasai | (Q)adasa | Please | [symbol] | One |
| [symbol] | Kuso | ® (Z)u(g)a | Feces; Shit: Damn it | [symbol] | Three |
| [symbol] | Kutushita | Ka(l)a(s)ita | Socks | [symbol] | Two |
| [symbol] | Kyoo | (Dh)a(w)o | Today | [symbol] | Two |
| [symbol] | Made | Ma(dh)i | P.M. | [symbol] | One |
| [symbol] | Machigatte | Ma(sh)a(qq)atu | By mistake | [symbol] | Two |
| [symbol] | Mata | ( [symbol] )a(w)ada | Again | [symbol] | Two |
| [symbol] | Matome | Maa (th)ama | Summing up | [symbol] | One |
| [symbol] | Medori | (Kh)a(dh)ara | Green | [symbol] | Two |
| [symbol] | Meishi | ® Sheime | Noun | [symbol] | One |
| [symbol] | Mesu | Me( [symbol] )a | Female (animal) | [symbol] | One |
| [symbol] | Mezu | (B)ezu; | Water | [symbol] | One |
| [symbol] | Mihon | Ma(sh)(tt)a(ra) | Sample | [symbol] | Three |
| [symbol] | Moue | Mo( [symbol] )aue | Superior | [symbol] | One |
| [symbol] | Mushoku | Musho(qq)a | Unemployed | [symbol] | One |
| [symbol] | -Nashi de | Na( [symbol] )i te | Without | [symbol] | One |
| [symbol] | Natu | (K)e(s)u(wa) | Summer | [symbol] | Three |
| [symbol] | Nen | ( [symbol] )am | Year | [symbol] | One |
| [symbol] | Nesshin | (L)e(kh)shin | Ardor, Enthusiasm | [symbol] | Two |
| [symbol] | Netsu | ® Se(kh)ana | Heat, Fever, Zeal | [symbol] | Two |
| [symbol] | Nichiwa | ( [symbol] )achi(y)a | Afternoon | [symbol] | Two |
| [symbol] | Niku | (L)i( [symbol] )a(m) | Meat | [symbol] | Three |
| [symbol] | Nozoku | Nozo(q)u | Snoop | [symbol] | One |
| [symbol] | Ohayu | ( [symbol] )ayu | Good morning | [symbol] | One |
| [symbol] | Ooame | (M)'( [symbol] )ooama | Heavy rain | [symbol] | Two |
| [symbol] | Ooen | ( [symbol] )oen | Support | [symbol] | One |
| [symbol] | Ooja | (Kh)ooja | King; Victor | [symbol] | One |
| [symbol] | Ookata | (W)o(q)ait | Almost; Probably | [symbol] | Two |
| [symbol] | Osore | (Gh)o(ss)ora | Fear | [symbol] | Two |
| [symbol] | Otto | ( [symbol] )atti(y)a | Father | [symbol] | Two |
| [symbol] | Rei | Rou( [symbol] ) | Soul | [symbol] | One |
| [symbol] | Roohoo | Raahoo | Good News | [symbol] | Zero |
| [symbol] | Ryokoo | Ryo(q)aa | Travel, Trip | [symbol] | One |
| [symbol] | Sagano | ( [symbol] )enka | Wit | [symbol] | One |
| [symbol] | Saibu | Saibu (enough) | Details | [symbol] | Zero |
| [symbol] | Sakka | Sa(qq)a | Writer | [symbol] | One |
| [symbol] | Sansei | Sa(l)sa(l) | Acidity | [symbol] | Two |
| [symbol] | Sei | ( [symbol] )ei | Life; Spirit; Holiness | [symbol] | One |
| [symbol] | Seido | Seido (Saint) | Shrine | [symbol] | Zero |
| [symbol] | Seigen | Sei(j)in | Limit; Prohibition | [symbol] | One |
| [symbol] | Seikatu | (Sh)ei(kh)atu | Living | [symbol] | Two |
| [symbol] | Seikou | Sei(q)ou | Elimination | [symbol] | One |
| [symbol] | Seirai | Seira/Siira | By nature; Inherently | [symbol] | Zero |
| [symbol] | Simi | ® (W)asa(kh)a | Stain | [symbol] | Three |
| [symbol] | Soba | Sobba/Chorba | Buckwheat noodles | [symbol] | Zero |
| [symbol] | Sokoshin | So(q)o(s)(l)i | Promotion | [symbol] | Three |
| [symbol] | Sokudo | So(g)udo | Rate of motion; Speed | [symbol] | One |
| [symbol] | Su | (Kh)a(l) | Vinegar | [symbol] | Two |
| [symbol] | Sugu | (T)a(w)a | Now, Right away | [symbol] | Two |
| [symbol] | Suutoobu | ( [symbol] )uutoobu | Stove; Heater | [symbol] | One |
| [symbol] | Shiboo | Shi( [symbol] )am, | Fat | [symbol] | One |
| [symbol] | Shiboo | ® Bish | Hope; Wish | [symbol] | One |
| [symbol] | Shira | Shira | Direction, Notification | [symbol] | Zero |
| [symbol] | Shitsu | ® ( [symbol] )a(n)oot | Room, Saloon | [symbol] | Three |
| [symbol] | Shoodo | Sho(h)odoo | Calligraphy | [symbol] | One |
| [symbol] | Shoodaku | (S)ooda(q)u | Approval; Consent | [symbol] | Two |
| [symbol] | Shoogai | Shoo(q)aa | Obstacle; Injury; career | [symbol] | One |
| [symbol] | Shoorai | Shorrai | Future | [symbol] | Zero |
| [symbol] | Shukoji | ® Koosha/Shukoshuka | Meal | [symbol] | One |
| [symbol] | Tabe-Tabe | (D)abe-(D)abe | Repeatedly; Frequently | [symbol] | One |
| [symbol] | Taitei | Taeta-taeta | Usually | [symbol] | Zero |
| [symbol] | Take | ® (Q)ade; | Size, Height | [symbol] | Two |
| [symbol] | Tobun | Tabuna | Divide equally | [symbol] | Zero |
| [symbol] | Tokei | ® (W)o(Q)it | Watch, Time | [symbol] | Three |
| [symbol] | Tokkyo | ( [symbol] )a(q)i(q)o | Patent | [symbol] | Three |
| [symbol] | Tori | (Tt)iir/(Tt)oyoor | Bird; Poultry | [symbol] | One |
| [symbol] | Tsuuka | (S)ikka | Currency, Passage | [symbol] | One |
| [symbol] | Uchi | ( [symbol] )u(sh)i | House | [symbol] | Two |
| [symbol] | Ude | (Y)ud | Arm | [symbol] | One |
| [symbol] | Ue | ( [symbol] )aa(l)i | Above | [symbol] | Two |
| [symbol] | Ume | ( [symbol] )uma (Swim) | Sea, Ocean | [symbol] | One |
| [symbol] | Un | ( [symbol] )un | Luck; Fortune | [symbol] | One |
| [symbol] | Uo | ( [symbol] )uo (t) | Fish | [symbol] | Two |
| [symbol] | Uppun | ( [symbol] )uffun | Anger; Frustration | [symbol] | One |
| [symbol] | Ura | Ura | Back; Behind | [symbol] | Zero |
| [symbol] | Uruoi | ( [symbol] )arui | Charm; Profit | [symbol] | One |
| [symbol] | Ushi | ( [symbol] )a(ss)i | Bull; Cow | [symbol] | Two |
| [symbol] | Uwaji | U( [symbol] )waiji | Clothes | [symbol] | One |
| [symbol] | Wakasa | (F)a(q)asa | Youth | [symbol] | Two |
| [symbol] | Washi | Wa( [symbol] )shi | Eagle | [symbol] | One |
| [symbol] | Wari ni | Warini | Comparatively; | [symbol] | Zero |
| [symbol] | Yama | (J)a(b)a(l) | Hill, Mountain | [symbol] | Three |
| [symbol] | Yasumi | Yasumu | Rest, Fast | [symbol] | Zero |
| [symbol] | Yorokubu | Yorokibu | Desire, Lust | [symbol] | Zero |
| [symbol] | Zai | Zai (Garment) | Wealth | [symbol] | Zero |
| [symbol] | Zende | Zende | Whole area | [symbol] | Zero |
| [symbol] | Zense | Zense/Zenuuss | Previous incarnation | [symbol] | Zero |
| [symbol] | Zoku | Zoku | Internal organ | [symbol] | Zero |
| [symbol] | Zoku | Zoku(ti) | Burglar | [symbol] | One |
| [symbol] | Zoodai | Zaado | Increase; enlargement | [symbol] | Zero |
| [symbol] | Zookei | (Dh)ookei | Knowledge; Mastery | [symbol] | One |
| [symbol] | Zowai | Zowai | Bribery | [symbol] | Zero |
| [symbol] | Zuan | Zua(q)/Zina | Design | [symbol] | One |
| [symbol] | Zure | Ziir | Gap | [symbol] (207) | Zero |

This corpus is not a cut and dried choice. Alphabetically I have chosen one hundred seven verbs, one hundred seven adjectives, and two hundred seven other, parts of the speech, than verbs and adjectives. Almost randomly, I tried to choose the prime number of four hundred twenty one (421) root words.

A) The first glimpse at this Long Range Comparison's (LRC) results is the outstanding following brand new facts:
1) Twenty seven (27®) reverses;
2) Eighty three ((83) [symbol] .
3) Sixty four (Q) alternations. It is the ( [symbol] q)
4) Fifty eight (58) [symbol] .
5) And other diverse two hundreds ninety two (292) other RDs.

B) As regards the 107 Verbs we have: (6®) (21 [symbol] ) (26 [symbol] ) (104 Alternations)=157 (RD)

C) The 107 Adjectives displayed (4®) (17 [symbol] ) (10 [symbol] ) (103 Alternations)=132 (RD)

D) The 207 Nouns, Conj. Part. Etc disclosed: (17®) (45 [symbol] ) (22 [symbol] ) (120 Alterntns)=(204 RD)

B) The 421 WORDS betrayed (27®) (83 [symbol] ) (58 [symbol] ) (64 Q) (292 RD)=(421 words)=(524 RD)

The above detailed corpus reveals the following conclusions:
A) Only thirty six (36) words among the whole corpus have three RD.
B) The remaining three hundred eighty five root words disclose only one eleven (1.11) RD.
C) One hundred seven words divulge an average of two RD.
D) Two hundred four—almost half of the corpus—expose a lonely RD
E) The thorough examination of the 421 NTC divulge a mere average of one twenty four (1.24) RD.
F) Interestingly enough, the study betrays that almost eighteen percent of the corpus has zero RD.

Sumerian alternations, Grimm law, Verner law, and Lauri Posti's dissertation (Annex V) confirm the same paradigm: Had they articulated BGC, Grimm, and Verner would have systematically encapsulated them in their main laws. Regretfully, nobody has tried this opportunity before our USPTO's application of The Cassidy Code on Feb. 9, 2005.

Assembly, all fictitious language family barriers and phyla boundaries seem to become totally superfluous, artificially manmade fences, and redundant hurdles. Any person of ordinary skill in the LRC of languages, and LOR, could apply Sumerian alternations with The Cassidy Code (Annex V) as an easy working template.

Hereafter the forty samples, easy to process with Sumerian alternations, and the Cassidy Code.

| HIRAGANA | ROMANIZED | TUNSI | ENGLISH | HATAKANA | RD |
|---|---|---|---|---|---|
| [symbol] | Aisimasu | ( [symbol] )aishu | Love | [symbol] | One |
| [symbol] | Arukimasu | ( [symbol] )aruku | Walk | [symbol] | One |
| [symbol] | Aserimasu | ( [symbol] )assara | Fade; Discolor | [symbol] | One |
| [symbol] | Chijimasu | (Q)i(z)imi | Shrink | [symbol] | Two |
| [symbol] | Erabimasu | Errab(ii) | Choose; Elect | [symbol] | Zero |
| [symbol] | Hazusimasu | ( [symbol] )azzuzu | Remove, Take off | [symbol] | One |
| [symbol] | Hikimasu | ( [symbol] )(u)ku | Run over; Grind | [symbol] | Two |
| [symbol] | Koimasu | (Q)o(ll)i | Ask | [symbol] | Two |
| [symbol] | Nikumimasu | Ni(q)uma | Hate | [symbol] | One |
| [symbol] | Torimasu | Toor | Take | [symbol] | Zero |
| [symbol] | Hoofu (na) | ( [symbol] )oof'na | full of | [symbol] | One |
| [symbol] | Kara | (Q)ara( [symbol] )a | Empty | [symbol] | Two |
| [symbol] | Kodai-na | (Q)odai-(m)a | Ancient | [symbol] | Two |
| [symbol] | Museigen | Mu(z)e(y)en | Variegated | [symbol] | Two |
| [symbol] | Nami (no) | Nami | Mediocre | [symbol] | Zero |
| [symbol] | Saigo (na) | Sai(b)ou | Final, End | [symbol] | One |
| [symbol] | Sanzana | (Z)anzana | Devastating | [symbol] | One |
| [symbol] | Urayameshii | Urayamashi | Envious | [symbol] | Zero |
| [symbol] | Ureshii | U(n) eshii | Joyful | [symbol] | One |
| [symbol] | Wabashii | Wabashu | Lonely, Dreary | [symbol] | Zero |
| [symbol] | Yabani | (J)aba(l)t | Uncivilized | [symbol] | Two |
| [symbol] | Akushu | Aka(h)u | Shake hands | [symbol] | One |
| [symbol] | An | ( [symbol] )al | Idea, Solution | [symbol] | One |
| [symbol] | Ao | (Dh)ao | Blue | [symbol] | One |
| [symbol] | Ayamachi | Ayama(sh)i | Fault, error; Blunder | [symbol] | One |
| [symbol] | Deashi | Da( [symbol] )(s)a | Start | [symbol] | Two |
| [symbol] | Geisha | (Q)ei( [symbol] )sha | Gueisha | [symbol] | Two |
| [symbol] | Gendoo | (J)endoo | Behavior, Discipline | [symbol] | One |
| [symbol] | Chome | ( [symbol] )oma | Quarter | [symbol] | One |
| [symbol] | Hiyouka | (A)haouka | Appreciation | [symbol] | One |
| [symbol] | Ima | Imma | moment; Now | [symbol] | Zero |
| [symbol] | Jochoo | Jaach | courage | [symbol] | Zero |
| [symbol] | Jooge | ® (Q)a(dd) | Measure | [symbol] | Three |
| [symbol] | Kompai | Kom(b)ai | Together | [symbol] | One |
| [symbol] | Koodoo | (Q)ooddoo | Behavior | [symbol] | One |
| [symbol] | Made | Ma(dh)i | P.M. | [symbol] | One |
| [symbol] | Shiboo | Shi( [symbol] )am, | Fat | [symbol] | One |
| [symbol] | Shiboo | ® Bish | Hope; Wish | [symbol] | One |
| [symbol] | Tori | (Tt)iir/(Tt)oyoor | Bird; Poultry | [symbol] | One |
| [symbol] | Tsuuka | (S)ikka | Currency, Passage | [symbol] | One |
| [symbol] | Zookei | (Dh)ookei | Knowledge; Mastery | [symbol] | One |

In conclusion one: This LRC's results represent a huge tectonic shift due MT threshold.

In Conclusion two: Ultimately, as regards the LOR, it is crystal clear that there is one and unique family of languages. Mother tongue is a Proto Language. All other languages are of the same family with different number of BGC.

In conclusion three: The four hundred forty one cognations are sui generis and a self explanatory discovery

### Annex I

### The Precession and the Forgotten Ice Age

Jane B. Sellers sought during her sixty years of research to assess and demonstrate that:
“Archeologists, by and large, lack an understanding of the precession and this affects their conclusions concerning ancient myths, ancient gods and ancient temple alignments. Philologists, too, ignore the accusation that certain problems are not going to be solved as long as they imagine that familiarity with grammar replaces scientific knowledge of astronomy. For astronomers, precession is well-established fact; those working in the field of ancient man have a responsibility to attain an understanding of if”.

The sun and the moon put forth a gravitational pull on the earth's equatorial bulge, provoking a very slow wobbling of the planet known as the precession. This peculiar phenomenon was discovered during the 1930's by Miloutin Malenkovich and reconfirmed by the recent discovery of the oxygen 18 in the oceans abyssal plains. Every half cycle of precession, i.e. 13,000 years represents an arc of 23° degrees latitude. Right now, we are at the apex of the wobbling cycle and the Arctic Circle is along Rovaniemi (Finland) and the Selkup homeland in Siberia, between the Taz and the Yenessey rivers' deltas. During the next half cycle of precession, i.e. the next 130 centuries, the Arctic Circle will recede and join its original site (43^{rd} parallel) south of Bordeaux, Geneva, Lake Baikal, and Beijing. Ergo, the Sahara, Arabia, and Gobi desert, will become a green forest.

This revolving precession phenomenon has maintained an eternal evergreen buffer zone covering the whole Mediterranean basin, starting from the 36^{hu} parallel south of the Atlas mountain (North Africa) and reaching the 43^{rd} parallel line south of Bordeaux, Geneva, Lake Baikal and Beijing and covering almost all Japan's islands. In this eternal evergreen forest zone grew the oldest and prestigious Mediterra cultures, beliefs and civilizations, let alone the beginning and the gradual development of the human language. This eternal evergreen forest zone has been the cradle of all human exodus to the eastern ocean Zur (i.e. the Pacific). A sacred pilgrimage to the venerable Sunrise, through the land of perpetual plenty.

Kepler explained thoroughly that the sun is at one focus of the earth elliptical orbit. The other focus of the ellipse is void. The position of the earth has a peritholion of 91 millions miles from the sun on January the third, and an aphelion faraway from the sun of 94½ million miles on the fourth of July, at the opposite side of the ellipse. The distance between the two focuses of the elliptic orbit is about 3.5 millions miles. The march of the four seasons is the end product of this orbital phenomenon. On the other hand Milutin Milankovitch (1938) published his astronomical theory of the ice ages. With the precession phenomenon Milankovitch has broken new ground for the earth climatology by drawing a special attention to the 23° of translation of the Saharan Area. The tilted earth revolution around the sun is somewhat affected by the wobbling phenomenon. It slowly & gradually modifies its inclination along the elliptic orbit and alters the duration of exposure to the Sun of some particular regions of the planet Earth.

The Ice Age: According to John and Katherine Imbrie (“Ice Ages”, solving the Mystery, page 11; Harvard University Press): “In North America, glacial ice spread out from centers near Hudson Bay to bury all of eastern Canada, New England, and much of the Midwest under a sheet of ice that averaged more than a mile in thickness. A second ice sheet spread out from centers in the Canadian Rockies and other highlands in western North America to engulf parts of Alaska, all of western Canada, and portions of Washington, Id., and Montana In Europe, the ice reached outward from Scandinavia and Scotland to cover most of Great Britain, Denmark, and large parts of northern Germany, Poland, and the Soviet Union.”

This period in the earth's history has come to be called the ice age.”

### Annex II

### Language Origins Research, LOR

Excerpts from the Paris Workshops (1997)
Chronological Frame (10 minutes, until 16:05) Presented as Introduction by Gyula Decsy, Goodbody Hall 141, Indiana University, Bloomington, Ind. 47405, USA.
Universe: 12-15 billion years
Earth: 4 billion years
Life: 2 billion years
Noise production: as old as air and motion (pre-pulonary noises/sounds)
Mammal pulmonary sounds: 60,000 years; phonemically H/E (?/a)
Humans: 4 or 5 million years
Bipedality: 3,6 million years; causes sinking of Larynx.
Unarticulated single-sound production with targeted call semantics (G. Revesz) in imperative mood appears (indicativization of communication): 200,000 years.
Sounds equentialization (birth of syllable); non-timbric sound sequences/syllables 100,000; (H?E; quantity, stress/intensity, pitch, register variables). Main speech communicative elements of Neanderthal.
Instinct-based reasoning: 70,000-80,000 years; time (tense) and modality.
Intensive sinking of Larynx: 35,000 years (Cro-Magnon).
Timbric sounds (oldest: u, I, aj, w, +nasal/nasalized velar consonants). 25,000 years. Chances for real iconicity given from this time on.
Perfection of pharyngovelar closure (anatomically, human [Cro-Magnon] only!: 20,000 years.
M, p, and t: (production of labials and stops becomes possible) 15,000 years
Bifurcation of voiceless media: (p/b, t/d, k/g) 12,000 years.
Monosyllabic units (CV) in large number with clear semantics: 11,000 years.
Red Marble Block products: (I/you [my/yours], light/dark, here/there, stay/go, good/bad [God/devil] 10,000 years. Note: concepts now reasoning-based; as instinctively:subhuman, (may be more ancient)
Beginning of abstraction ability on a broad base mainly by introducing the 3^{rd} person: 9,000 years
Multilingualism begins Unfolding individualized-separate sound sequence production in local isolated clans: 8,500 years
Multisyllabicity (Posysyllabicity). Little professor at the campfire (inventionalism): 8,000 years.
Protolanguages (Indo-European, Uralic, Turkic, Mongolic, Semitic, Austro-Tai, etc.) in their shape: 8,000-7,000 years.

### Syntax and Morphology: 7,000-6,000 B.C.

Abstract vocabulary: 4,000-1,500 B.C.

### Linguistic Sophistication 500 B.C.

### 2.3 Relevance of Recent Very Ancient Fossil Finds for Language Origins Theories.

Presented by Professor Dr. Marge E. Landsberg, University of Haifa, 1, Shikmona Street, Bat-Galm, Haifa 35014, Israel.
I would like to discuss the significance of the discoveries of the oldest fossil of human ancestors to be found together with stone implements and animal bones in northern Ethiopia by American, Ethiopian and Israeli scientists (this discovery is believed to be 2-3 million years old, cf. William Kimbel & Erella Hovers & Yost Rak, in the December 1996 issue of the Journal of Human Evolution), and Mary Leakey's announcement that their fossil discoveries in Tanzania and Kenya indicated that man's evolution began in East Africa far earlier than had been believed (cf. report on footprints found in volcanic ash that showed early hominids walked upright 3.5 million years ago), for a theory of language origins. Fortuitously, of course, these findings prove my own and P.V. Tobias' theories as having been correct at the time.
[A pre-print version of the article (not to be quoted without author's consent) is available on request.)
2.5 Recapitulation of the Phylogenesis by Ontogenesis. (Guyla Décsy)
Ontogenesis has a different developmental rythm (time spans for language acquisition) than phylogenesis.

### Stages of Language Acquisition

Synoptic diagram with statistics based on

4 million years of phylogenetic age of mankind (left column),

35,00 years of language ability of man (also left column), and

70 years average human life-span (right column, onmtogenesis).

Improved version after Semiotica 78:3-4 (1990). 353. We assume 35,000 years for development of the human language ability (from 35,000 B.C. to 2,000 A.D.) For technical reasons, data somewhat different from the chronological frame on p. 3-4 of this convolute. Ontogenetic data based on Peter A. Reich's book Language Development, Englewood, N.J.: Prentice-Hall 1986, 387 pp., see my review in: Ural-Altaische Jahrbucher/Ural-Altaic Yearbook 61 (1989). 174. Months on the ontogenic side are regarded as 1/12 of year (12 months); year fragments are 0.4=three months, 0.6 half a year, etc., on the ontogenesis side).

| | (4 million years) | (70 years) |
|---|---|---|
| Subhuman/Prehuman till 35,000 | 99.75% (−0)-0.6(0.2) | 0.28% |

| | Phylogenesis | % | Ontogenesis | % |
|---|---|---|---|---|
| With language | 35,000 years | 0.27% | 69 years | 98.72% |
| Separate timbric | 25,000 (10) | 28.57% | 0.5-0.8 (0.4) | 0.6% |
| sounds | | | | |
| Soundsequences | 24,000 (2) | 2.85% | 0.8-1.0 (0.4) | 0.6% |
| (timbric) | | | | |
| First 50 words | 22,000 (2) | 2.85% | 1.0-1.5 (0.2) | 0.3% |
| 300 words, phrases, | 20,000 (2) | 2.85% | 1.5-2.3 (0.8) | 0.7% |
| inflection | | | | |
| Creative | 10,000 (10) | 28.57% | 2.3-3.0 (0.7) | 0.7% |
| constructions | | | | |
| Syntax post- | 5,000 (3.5) | 14.28% | 3.6-6.0 (2.5) | 3.8% |
| Abstract vocabulary | 1,500 B.C. | 10.00% | 6.0-10 (4.0) | 5.7% |
| Linguistic | 500 B.C. | 7.14% | 10-25 (15.0) | 21.4% |
| sophistication | | | | |

### 3.1 The Wundt-Principle: a Basic Observation (Chair)

Basic observation formulated as early as 1922 by Wilhelm Wundt in his Volkerpsychologie: The sound is gesture (Der Laut is ein Gebarde). Details Decsy 1983.102. In this sense, the language—and even the sound production—is certainly of gestural origin. Gestures as result of motion are very old, centered in the archaic parts of the brain (cerebellum). However, in the brain the speech centers are located in the neopallium (Brocka/Wernicke areas). Speech production is, according to this, a relatively late fine-modulative non-motoric motion topologically quite far from the mostly motoric-reflexive steering center in the archaic parts of the human brain.

### 4. Physei/Thesei: Relation Between Concept and Sign

### 4.1 Terms

Ever since Plato, linguists have tried to find an appropriate term to designate the two basic types of relation between concept and sign. We prefer the terms printed in Italics.

| Physei | Thesei/nomoi | Plato |
|---|---|---|
| Tonikonism | Tonsymbolik | Décsy (in German) |
| Direct | indirect | See Décsy 1981.16 |
| | | (Sprachherkunftsforschung II). |

Note:
1. Our present-day languages operate on a theseic (non-iconic) basis.
2. The signs of animals are mostly theseic and not iconic (Décsy 1983.61 with references).
3. Anti-iconism is a powerful factor in the operation of human communication. A sign can be iconic at its creation and rise; however, in practical use, it soon becomes a symbol (Décsy 1983.38).

### 7.2 A Statement for the Language Origins Society (Amsterdam, the Netherlands).

### Language Origins Research: From Prohibition to Positive Contribution.

Presented by Dr. Bernard H. Bichakjian, President, Language Orgins Society, Katholicke Universitet, Department of French, P.O. Box 9103 HG Nijmegen, The Netherlands. The Language Origins Societe was founded in 1985 in Crackow, Poland. In 1996 (Membership Directory) 210 members from European and overseas countries.
Though dogmatic behavior is by no means a rarity within schools of thought, scientists would readily agree in principle that no anathema should be cast on any type of research leading to a better understanding of observational data. And in the name of such a principle, one is ready to condemn the Société Linguistique de Paris for banning the presentation of papers on language origins.

### It was an Act of Censure, Something Hardly Suited for a Learned Society.

Yet, if the procedure was unquestionably wrong, the underlying concern was not spurious. The fundamental question that the decision makers were asking themselves was whether, on the strength of their expertise and on the basis of the empirical data from known or reconstructed languages, linguists could propose scientifically acceptable hypotheses on the origin of human language. This was a responsible question to ask, and experience had convinced them that the answer should be no. Thence to ban. Today, while the ban has long been lifted, the fundamental question is still there. Can linguists contribute to language origins research? The answer is an unequivocal “yes”, but we have to be careful not to overreach. Reconstructing proto world like scholars reconstructed Prot-Indo-European is not one of the options. We can however, in cooperation with population geneticists, draw the ultimate genealogical tree of the world's languages. This is already done with reasonable success. But we could make a far more meaningful contribution by tracing the development of linguistic features and by inferring the principles that have guided the evolution of languages. But that would require the abandoning of a cherished myth, and mainstream linguists are not ready for it

In the eighteenth and nineteenth centuries, it was fashionable to believe that evolution was de cyclical process. The Scottish geologist James Hutton saw the earth as a perpetual machine which, in the words of his catchy phrase, displayed “no vestige of a beginning, no prospect of an end.” The British geologist and naturalist Charles Lyell extended Hutton's view to the history of species, but the theories of Lamarck and Darwin combined with the evidence from molecular biology soon proved that the cyclical account was a complete fallacy. In geology, it was the theory of the Big Bang and its supporting evidence that dealt a fatal blow to the cyclical dream. Today, Hutton's and Lyell's uniformitariansm is completely rejected, and the time's arrow has replaced the time's wheel.

Mainstream linguists unfortunately have not come so far yet—they passionately cling on to the cyclical idea and reject the evolutionary approach with contempt and visceral aversion. As a vector of literature and philosophy, language has of course an undeniable cultural dimension, but the linguistic implement is also just that, an implement with a biological dimension of its own. It is therefore imperative for linguists to examine the neuromuscular underpinnings and assess the selection ressures that weigh upon them in order to understand the nature and the developmental history of the linguistic features they support. This is the task that awaits today's linguists. If they should accept to carry it out, they will be able to outline the developmental steps of the linguistic implement and uncover the process that has guided its evolution. Such an endeavor will not reveal the features of the ultimate protolanguage, anymore than the phylogenetic survey of primates would yield the blueprint of invertebrates, but it would help us understand the developmental process and guard us against embarrassing assumptions about the ancestral vernacular. That would be the contemporary linguist's contribution to language origins research, and it would not be an insignificant one.

### Annex III

### The Cassidy Code

Awareness about Basic Guttural Consonants, BGC, perdurable presence, since illo tempore, in Hamito-Semitic languages, and conspicuous absence anong Indo-European and Uralic languages, raises a case of interest. Tunsi Long Range Comparison, LRC, with English and Suomi languages entails discovery of regular differences, alternations, and reversal patterns hidden in the data. A brand new approach emerges facilitating languages LRC, and easing Language Origins Research.

The Cassidy Code is Sumerian, Grimm and Verner Laws sequel, alternating BGC with mostly unvoiced consonants or apocope entailing a forward shift of articulation basis, due finer pronunciation, and adding the transmogrifying reversals. The idea is to put forward a parallel code, in LRC of languages and LOR quests, to the focus on separate wide swaths of straight cognations. Predictably, Sumerian alternations, as well as their sequel might play a pivotal role in the LOR, due MT, according to the following BGC alternations gamut.

| | | | | | | | | |
|---|---|---|---|---|---|---|---|---|
| BGC | ▾ | ∞ | ∞ | ∞ | ∞ | ∞ | ∞ | ∞ |
| Gh | ▾ | G | W | F | Ng | | | |
| Dh | ▾ | D | Z | S | B | | | |
| [symbol] | ▾ | K | W | G | T | Ng | Ll | Gl |
| Kh | ▾ | J | Y | Sh | H | LL | S | |
| [symbol] | ▾ | W | V | Sh | H | S | F | L |
| H | ▾ | K | S | Sh | [symbol] | T | [symbol] | |
| [symbol] | ▾ | H | S | Sh | D | K | F | L |
| Th | ▾ | T | D | K | Z | | | |
| Th | ▾ | T | D | F | S | | | |
| Ss | ▾ | T | D | S | Z | | | |
| Tt | ▾ | T | S | Sh | Z | | | |

The Cassidy Code is sui generic. Its three pillars (apocopy, alternations, reverse) made it unprecedented, unheard of before February the ninth of 2004, unfussy, unflappable, unique, universal, unequivocal enforcer, and not likely to be surpassed. Take it out of the picture, and there is no telling what might have happened to the cognations.

Hereafter alternation and reversal samples easy to process according to the Sumerian alternations, and The Cassidy Code: tafsha ∞θ spot; mermez ∞θ simmer, kif ∞θ wiselshape; raka [symbol] ∞θ ∞ secure; kyf ∞θ fun; nefa [symbol] a ∞θ weapon shnowa ∞ ∞ clue know ∞∞ monk; ghamza ∞∞ wink; [symbol] ewa ∞▾ eva; tell [symbol] abib ▾ ∞∞ Tel aviv; tharwa θ worth; thor (ox) θ roth; woh θ how; chum θ much; rou [symbol] ∞ θ soul; elä [symbol] ä ∞ elävä (Sm) ∞ ▾ life; dooleb θ blood; sälä [symbol] ä ▾ sale; [symbol] ara ∞ four; [symbol] oma (neighborhood) ∞ home; [symbol] oush ∞ house; khif ∞θ fix; Yousef ∞ Joseph ∞ Jehovah (Hb) ∞ kasem (Ar), Guiseppi (It); ra [symbol] ama (Ar) a ∞∞θ masr (Egypt); [symbol] aram, center ∞ haram (Ar) Pyramid; Sellälä V Selälä (Sm) ∞ Sunna (Ar) ∞θ Legacy; [symbol] oka θ Bokh ∞ box

Jellaz ∞ Dallas ∞ Colli(na)s (Sp) ▾ ∞ Ellas ∞ Ellah ∞ [symbol] ay (Sum.)
(Eastside, Sunrise, Holy Ground, cemetery)

| | |
|---|---|
| Dhaw ∞Day ∞ Daw(n) ∞θ God; | Ydhahhak (Laughter) ∞ Izahhak ▾ |
| | ∞ Isaac (Hb) ∞θ Cassidy; |

### Annex IV

### The Tunsi Language

The Tunsi is a highly evolved, agglutinative language. Morphemes of known general meaning are glued together in speech, to convey a third distinct meaning. Flexible, resilient, affluent and witty, this old language shows no trace of arthropathy, like the majority of agglutinative languages. The Tunsi Language is part of the Berber phylum of languages, which is known as the Hamitic branch of the Proto Hamito-Semitic Language. Conversely the Arabic language follows the unique tri-consonantal pattern for all the basic verbs. Ten derivations from the basic verbs encompass the whole basic vocabulary. Vocalization of the three basic consonants completes all its grammar.

How to define a Berber?. According to the “Encyclopedie Berbere” (p. 12):
“Est Berbere ce qui n'est pas d'origine etrangere, c'est a dire ce qui n'est ni punique, ni latin, ni vandale, ni bizantin, ni arabe, ni turc, ni europeen (francais, espagnol, italien)” . . .
   The fundamental characteristics of the Tunsi are the morphological, syntactical aspects delineated in the next 40 entries:

1) Basic Guttural Consonants: “L'Encyclopedie Berbere” (Tome I.40) delineates the Berber alphabet as follows:

| | |
|---|---|
| “Labials: | b, f, m. |
| Velars: | γ (gh), x (kh) |
| Dentals: | d, t, d (dh), [symbol] (th), n |
| Sifflantes: | z, s, z, s |
| Chuintantes: | zh (‘j’ French), s (‘ch’ French) |
| Palatals: | g, k, q |
| Liquids: | l, r, R |
| Pharyngeals: | ε (‘ain), [symbol] |
| Laryngeals: | h |
| Affricates: | ts, dz, |
| | \check{c} (tch), \check{g} (dj) |
| Semi-Vowels: | y, w.” |

The ten BGC are the following: dh, [symbol] , gh, kh, q/ [symbol] th, Th, Ss

In our LRC of languages we must carefully manipulate the comparison of one Hamitic language, which is endowed with all the most archaic primordial elements of the human sound sequence language, with two languages, completely deprived of all these ten primordial BGC.

2) The doublet homosyllabic (198) verbs (cf. pp. 30-32): Two syllables, with opposite emphasis, stressed and unstressed. A balanced pair of closed syllables, (CvC), with four consonants. A tetragrammation, a divine perfection, just like the genes in a live cell

3) The doublet heterosyllabic (594) verbs (see Annex V).

4) The agglutination system by which the meaning of the phrase is articulated by a quadriletter word.

5) The root of verbs and nouns remain unchanged. The first closed syllable is the root of the word. In Arabic all the vowels vary. Conversely, in Tunsi vowel inflection always occurs only in the second closed syllable.

6) Preposition “ät/at” for intransitive verbs, (also in Livonian): ät jabbes stick, ät jabbed leave, ät rabbis wait, ät bäznyt move slowly, ät mällä [symbol] don't care, āt lāwwā [symbol] assault, āt shā [symbol] bāt climb up, āt [symbol] āzzāz difficult to get, āt zāεbān resist, āt rākkāk annoy, āt wā [symbol] wā [symbol] suffer intensely, āt rā [symbol] rā [symbol] expand, āt ka [symbol] bār get round.

This preposition exists in almost all Berber dialects as: ad, at, alt, etc . . . .

7) Exceptions to the rule of biletter or quadriletters verbs: there are several tri-consonantal Tunsi verbs: xazar stare, [symbol] athar stumble, naghar negate, qafaz outstand, shata [symbol] dance, [symbol] aras be serious, rābā [symbol] earn, [symbol] ārāf nose bleeding; kārāf surmise; salakh slaughter, ghamaz wink, [symbol] ā [symbol] ās sneeze, [symbol] āmās be upset, [symbol] āmāz kick, fālāt escape, qaras pinch; mā\check{g}ādh chew, ghalas dive.

8) The imperative mood: Prime words had been orders or requests (usually in one closed syllable (CvC): jib give, qom come, shed grab, hiz take, hāt upfront, ro [symbol] leave, shem smell, rod pay, herr talk, door turn, diz push, ty [symbol] fall; aya go, fyq wake up, qirr confess, lyz insist, ross squeeze, qus cut, shuf look, xalli leave, mos suck, boos kiss, yoz seize, qyd handle, sob pour, xodh (shake), xoodh take, sād close, ko [symbol] cough.

9) The verb Wolla (to be, to become) and its evolution to only (o), like in: mä o mäshit, tä o tämshi, hä o mäshä he is gone. The same process occurred in Suomi (Finnish), from Wolla (to be) it became Olla, and from mina olen, tinä olet, it mutated to: mä on I am, tä on (you are).

10) The existence of a thematic harmony of vowels. Front and back vowels ā and a, ö and o, and the median e and i.

11) Derivatives by means of suffixes: dis, hide, Ra-dis, sun-set; haa like>Ra-haa, grinder; Ra-Bux (God-Ra),

12) Peculiar process in the formation of adverbs: [symbol] äräbha, hubris; seibo, enough; ekhit, disgusting; iffit, stinky; la budda, no but; immälälä, of course; māzāl, not yet; bel [symbol] ani, deliberately; shāmātā, spite; tālāni, last;

13) Adjectives: nabra brand new, douni mean, [symbol] āsidā dicey, xorda ruined, botti fat, [symbol] awi senile, rāzin heavy, wise, rawi healthy, [symbol] irfi raw, māssous spiceless, māhāf clever, derwish shrewed, ārguit agile, mi [symbol] ā sticky, mhl [symbol] great, [symbol] ashir friend, [symbol] ānān brown, suuri tall, māsri short, berish red, tārmyz smart, qarous dark, shelbā white, jifā stinky, tātā dumb, shāārif elder, [symbol] ālloush lamb, very young.

14) The system of declension by means of casual prefix, and suffixes: Genitive case by the prefixe “m”: m'derbal thickky, mwwāj skew, m'bāzzāε overlapping, m′bārqāsh adorned, m'louleb fitting, m'zāwwār clever, m'bāssās tender, m'zāyyān motley, m'sāttāk retarded, m'zāwwāq variegated, m'sācwwāf rotten, m'fāwwā [symbol] spicy, m'jābbār casted, m'dārwāl foolish, m'εākrāsh curvilinear.

Illative case (illa): qirbillā smart, leikillā playing;
Partitive case (ta): bolta half half, xoltā aquaintance;
Inessive case (issa): [symbol] alawissa dumb; condlissa candlelike; sissān roots.

15) Ideophones: they are different from interjections and paralinguistic expressions. They delineate silence, color, smell, temperature, speed, duration, different moods, and even different manners of walking: Shārshār trickle, wāshwāsh whisper, shārnān tinging, zāghrāt hubbub, gārgār rattle, neghnegh deny, zāwwāk cry noisily, daddash move slowly, neggaz leap, qashqash check, kashkash foam, da [symbol] da [symbol] fatten, zāwwāq color, wāshshām tattoo,

16) There are four different forms of plural and dual:
a) By adding the infix u after the first consonant: Gabsi/Guabsia.
b) The archaic collective plural by reduplication of the word itself: cus, center, pi. cuscus; and ber pink/red pl. Berber occidentals.
c) A third form of plural by an end word suffix n: [symbol] al solution, [symbol] alfa creation, [symbol] alfawi creator, [symbol] alfawi-n, pl. creators.
d) The suffix (wi) for the doer. The suffix (gi): guerba, goatskin, guerbagi water supplier, plural with a suffix (a): guerbagia.

17) The plural marker in conjugation is, also, the suffix u: nshuf, I see, tshuf, you see, nshufu, we see, tshufu, you, yshufu, they see.

18) The existence of a negative conjugation unknown to any other language phyla: ma . . . sh, without; mātā>shāmātā, spite deliberately. Like Malaisian, ma . . . bu, and French ne . . . pas.

19) Presence of infixes in Tunsi verbs and negative conjugation.

20) The prefix, tā/ta is a definer: tämäzigh, the forest dweller; tätäouin, the mountain; tātuän, the pillars; täzärkä, the blue, tämärzä, the port; täkrunä, crown; täjärouin, tābessā, watery; tāmozrot, Tābārqā, Tāburbā virgin land, Tāj/tāz apex, etc . . . .

21) Suffix ‘nä’ meaning ‘like’ >bodään bodylike. Or the ‘doer’: [symbol] ännä henne, [symbol] ännänä the applier of henne; fousha>foushana brushlike, shousha bulge>shoushana outward curve.

22) Suffix ‘haa’ as ‘likeness’: luhaa wood, bonelike, rahaa grinder.

23) The opposite by the suffix (wa): da illness>dawa medecine; Ghod light>Ghodwa tomorrow, darkness, night, beginning of the next day.

24) Suffixes: dis hide> [symbol] adis lentils, radis sunset, west; ālā>nemālā aunt, rottilā tarantula.

25) The suffix Dha excess: khodha brouhaha, khomadha chamade

26) The future expressed in Tunsi by the preposition “besh”. Importance of the word “be”: ash beek?, what is the matter?; matha biya, I would like, besh, will do in the future, bel by the means of.

27) The letter F, as a formative consonant: fārā leg's calf. fār/far is the root for fārzit cigale, fārzazou drone, fārεoon pharaoh, fārtās bald, fārfār purple, fārāwlo strawberry, fārtāttö butterfly, fārqā [symbol] overlap, fārshāx destroy, fārεās put in shambles, fa r̅gād disseminate, fārkās fetch, fār [symbol] āq brag, fārqā [symbol] explode, fārrāk dissemble, fārrāq separate.

28) Categories of forests: Shel (forest): shel [symbol] ā (forest language), shelyum (mustache). Shelilā (eastern side, sunrise). Meshtā>mehta>metta>messa>mekka>maze>meda: (hill forest); wor (forest): worgala (large forest); fer (plantation): feriana (forest like); rif (rural); woodrof (woodrow); foushānā (brushlike grove).

29) For our food gatherers forefathers: ghalla (fruit); Senegal, Portugal, Galicia, Gaule, Galles, Wales, are at the MEZ sunset side

30) Fās [symbol] ain, eyeiris; fās [symbol] adhma, yoke; fās bellara, glass. The concept is separation. And Qāfās, cage, cubicle with six obstacles.

31) Coupling, two entities, in the same word: Zāgh small mountain, an water, became zāghwan; qara due west, an>qarwan; Ra sun, Bukh God: the power beyond the sun, became Rabukh=God Ra; Ra sun, Sham plantation>Rasham drawing.

32) Special expressions: Woh, how; haka like this, hakaka got it; tarah? show me; [symbol] al solution, [symbol] ala bad shape, [symbol] alila very bad shape, [symbol] alilto cute, [symbol] alawet sweet; fej way; fāllā duct through; [symbol] ājjā scrambled> [symbol] ājj-āj dust

[symbol]

ājj-āb miracle> [symbol] ajj-ālā agility; [symbol] ajj-im first, [symbol] ājjin dough; annil/allil creation/Nile, annul loom; siblā excuse.

33) Words of agreement: hakaka (got it), Yakhi (ergo), tawtaw (now)

34) Dilemma: Ämä hākā—willā hākā last choice: this or that.

35) Quantities: kaεba (piece), tarf (part), shaber (span), dhrac (cubit), oqeya (ounce), balyon (gallon), flous (quantity of money), barsha (several), nod (lot), kamsha (handcatch), εanqod (grapes), εarjoun (bundle), saε (2.5 kgs), wyba (26 kgs), qafiz (16 wyba), qartalla (oblong basket), sandouq (case), kila (size), [symbol] arbusha (pill), [symbol] āfnā (handful), sālεā (merchandise).

36) Cooking and baking: tābexa to bake<bejā=bexā<vega. All of them originated from the word Bokh=box, from which we had RaBokh God Ra, boxor encens, bāwwāx generate vapor. As we know baking is heating to a degree several ingredients. We have a choice of meals: marqa gravy, molokhiya milk like, [symbol] sew stew, m'darbal thick gravy, bissārā mashed peas, [symbol] āsydā dicey, tajin quiche, mā [symbol] joun jam, m'jāmmār crispy, m'rāwwāb ripe, tāxtox gravy, moqly fried), meshwi/boshmāt roasted.

37) Direction: ghā-di, ghadika, ra-dis, Bou mer-dās western side, sunset).

38) Word for attention: bāl, bālikshi?, let see?, jā [symbol] ālā bāli crossed my mind; bārā bālik, go your side; bola a pee.

39) Expressions of wonder: Izzā [symbol] ?, Saturn like: zah-muel, Saturn shining, zo [symbol] -al, Saturn invisible; Izzār? plenty.

40) The Tunsi-English LRC (660 words) (Dr. Noureddin Zahmoul, The Cassidy Code. 2005, 54-63): all these words are metasomatic, having undergone one or several RD metamorphosis. For only these 660 English words we enumerate 171 apocope, 525 alternations, 16 assimilations, 4 metathesis, and 367 reversals. A total of 1083 metamorphoses meaning an average of 1.64 degrees of separations between the 660 words of the two languages. 122 out of the 660 English words have undergone only one metamorphosis.

### Annex V

Lauri Posti Dissertation

### Studies in Linguistics Vol. 11, Nos. 34, 1953

Posti, Lauri, From Pre-Finnic to Late Proto-Finnic: studies on the development of the consonant system. Helsinki, 1953, 91 p. (Finnish-ugrische Forschungen 31, Fasc. 1-2). [P60.D1125. Reviews: Finnic languages—Historical phonology.] Reviewed by Alo Raun, Indiana University. The subdivisions of this article, treating the various changes, are:

| 1. | The change | s > h |
|---|---|---|
| 2. | The treatment of | ts |
| 3. | The treatment of | ts |
| 4. | The treatment of palatalized consonants | |
| 5. | The disappearance of n as an independent consonant | |
| 6. | The change | −m > −n |
| 7. | The change | mt > nt |
| 8. | The treatment of | kt |
| 9. | The treatment of | pt |
| 10. | The change | ti > si |
| 11. | The treatment of nasal + stop in syllable-final position | |
| 12. | The alternation | s > h |
| 13. | The assimilation | ln > ll |
| 14. | The treatment of | sn |

| | |
|---|---|
| 15. | The treatment of stop + sibilant in syllable-final position |
| 16. | The loss of v, j under certain conditions. |
| 17. | The origin of gradation. Posti is especially interested in |
| | this problem: “How are we to explain the fact that so many |
| | important changes took place within this relatively short |
| | ⁽¹⁾ period?”(p.2). According to him (87) during the |
| | Proto-Finnic period ten ⁽²⁾ consonants were lost, such as |
| | were lacking in Proto-Baltic or Proto-Germanic or in both of them. |
| | Therefore Posti attributes the consonant changes 2, 4, 7, 8, 9, 13, |
| | 15, and partially also 2, 3, 6, and 14 to Germanic influence, and 5, |
| | 10, and partially 2, 3, 6, and 8 to Baltic influence. Also Posti holds |
| | it possible that the gradation (no 17), also called ‘quantity alternation’ |
| | ⁽³⁾ or ‘stage shift’ ⁽⁴⁾ was caused by Verner's law in |
| | Germanic’ (90, details 76-81). Thus, only the changes 11, 12, |
| | 16, and partially 14 would be free of foreign influence. According to |
| | Posti the Proto-Finns borrowed ‘a great number’ ⁽⁵⁾ of |
| | loanwords both from Proto-Baltic and Proto-Germanic. ‘There may |
| | have been areas with a mixed population and with a considerable |
| | number of bilingual speakers’. The last paragraph of Posti's article: |

When the bilingual speakers of Baltic or Germanic origin spoke Finnic⁽⁶⁾, they pronounced it according to their own speech habits. If there were consonants or consonant-groups in Finnic, which did not occur in their own sound-system, they substituted the closest equivalents of their own language. These pronunciation habits were adopted by the neighboring Finnic population of ten perhaps because of the higher social prestige of the foreigners. Gradually the new pronunciation, with such minor modifications as the Finnic sound-system may have made necessary,⁽⁷⁾ spread over the whole Proto-Finnic area. Thus we can say that the majority of the Proto-Finnic consonant changes are due to a Baltic or Germanic superstratum. It should be noted, however, that the changes caused by Germanic influence are by far more numerous that the changes due to the Baltic contacts. (90-1).

What I claim as my invention is the following:

1. “Had they possessed all the twelve Tunsi's Basic Guttural Consonants (BGC) pronunciation, the Japanese people would easily have articulated, the same way as the Tunisian people do, the above delineated, Nippon Tunsi cognates, in the corpus of one hundred seven verbs, one hundred seven adjectives, and two hundred seven nouns, conjunctions, particles, etc... The Sumerian alternations and the Cassidy Code knack brought forward proof of a simple average (1.24) one twenty four Regular Difrerences (RD), or Degree Of Separation (DOS) in the four hundred twenty one (421) cognations.”.
